(19) United States
(12) Patent Application Publication
(10) Pub. No.: US 2011/0112983 A1
(43) Pub. Date: May 12, 2011

(54) Program trading platform

(76) Inventor: Tung-Ying Wu, Kaohsiung City (TW)

(21) Appl. No.: 12/656,346

(22) Filed: Jan. 27, 2010

(30) Foreign Application Priority Data
Nov. 9, 2009 (TW) 098137948

(51) Int. Cl. G06Q 40/00

(52) U.S. Cl. 705/36 R

(57) ABSTRACT

A program trading platform is revealed. After becoming members of the program trading platform, investors not only can select investment strategies provided by strategic providers according to ratings and verification of the investment strategies, but also can complete authorization and access of the investment strategies automatically through the trading platform. The investors do not need to find the strategic providers for obtaining the authorization. Moreover, various authorized investment strategies are combined and analyzed by the investors so as to achieve the optimal performance. Furthermore, the trading platform can be set by the investors to place orders automatically according to their investment portfolio. Thus the trading platform is of greater practical value.

### BACKGROUND OF THE INVENTION

1. Fields of the Invention

The present invention relates to a program trading platform, especially to a trading platform applied to investment trading for allowing investors to select investment strategies provided by strategic providers according to ratings and verification of the investment strategies after investors becoming members. The trading platform also completes authorization and access of the investment strategies automatically so that the investors don't need to find the strategic providers for getting the authorization. Moreover, various authorized investment strategies are combined and analyzed by the investors so as to achieve the optimal performance. Furthermore, the trading platform can be set by the investors to place orders automatically according to their investment portfolio. Thus the trading platform is of greater practical value.

2. Descriptions of Related Art

While making various investments, people always collect and analyze lots of information in order to avoid losses. But most of these investors are not professional investors and the data available is insufficient to make profitable investments. Thus strategic providers are starting to provide such business services. Due to professional knowledge and skills, the strategic providers make data collection and analysis become more effective, and provide more profitable investment strategies. In order to get higher profit during the analysis and development process of the investment strategies, strategic providers often upload their investment strategies to related network platforms correspondingly. Thus they can authorize users (investors) access these investment strategies.

As to the network platforms placed with investment strategies, the network platform offers investment strategies from strategic providers in real time and published to investors for their reference. On the network platform, the investment strategies offered by the strategic providers are arranged in an order according to their performance. Thus once respective investor is interested or confident in investment strategies of the strategic providers, he can contact with the strategic providers for authorization and access.

However, although the above network platform allows investors to check and obtain investment strategies they required, it has a serious shortcoming in practice. Once the investors are interested in investment strategies offered by strategic providers and are intending to get the investment strategies, they need to contact and negotiate with strategic providers one after another. This is not only labor and time-consuming, but extremely troublesome and inconvenient. Thus there is still a space for improvement.

### SUMMARY OF THE INVENTION

Therefore it is a primary object of the present invention to provide a program trading platform that allows investors to select investment strategies provided by strategic providers according to ratings and verification of the investment strategies, but also can completes authorization and access of the investment strategies automatically. Thus investors don't need to find the strategic providers for obtaining the authorization. Moreover, the investors can combine and analyze various authorized investment strategies so as to achieve the optimal performance. Furthermore, the trading platform places orders automatically according to investors' investment portfolios and settings. Thus the trading platform provides greater practical value.

In order to achieve above object, a program trading platform of the present invention includes an online database, a portfolio analysis module, and an automated order module. In the online database, strategic providers offer various investment strategies and a strategy verification of the investment strategy provided by the strategic provider is performed. Moreover, the online database also holds a strategy competition. Simultaneously the online database gives the investment strategy an investment rating to determine which grade the investment strategy falls into. After getting authorization to access to the investment strategy, investors combine and analyze various investment strategies by the portfolio analysis module of the trading platform. Furthermore, the automated order module of the trading platform allows investors placing orders automatically according to the authorized investment strategies and related settings.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a diagram showing structure of an embodiment according to the present invention;

FIG. 2 is a screenshot displayed on a computer monitor;

FIG. 3 is another screenshot displayed on a computer monitor;

FIG. 4 is a further screenshot displayed on a computer monitor;

FIG. 5 is a further screenshot displayed on a computer monitor;

FIG. 6 is a further screenshot displayed on a computer monitor;

FIG. 7 is a further screenshot displayed on a computer monitor;

FIG. 8 is a further screenshot displayed on a computer monitor;

FIG. 9 is a further screenshot displayed on a computer monitor;

FIG. 10 is a further screenshot displayed on a computer monitor;

FIGS. 11(a)-11(c) is a further screenshot displayed on a computer monitor;

FIG. 12 is a further screenshot displayed on a computer monitor;

FIG. 13 is a further screenshot displayed on a computer monitor.

### DETAILED DESCRIPTION OF THE PREFERRED EMBODIMENT

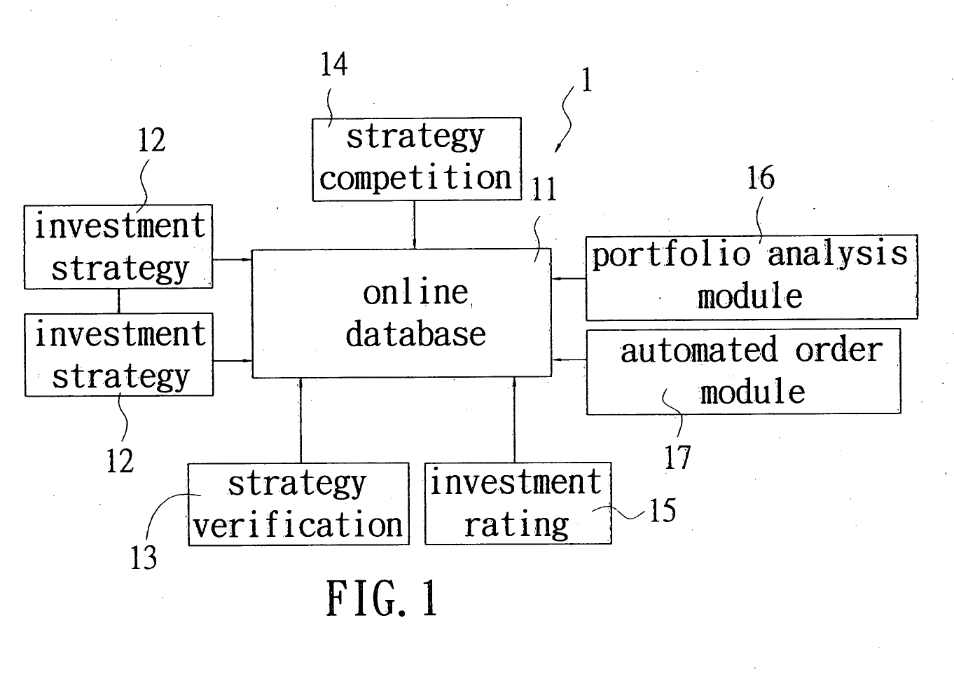

Refer to FIG. 1, a trading platform 1 of the present invention includes an online database 11 in which strategic providers offer various investment strategies 12 and strategy verification 13 of the investment strategy 12 provided by the strategic provider is performed. Moreover, the online database 11 also holds a strategy competition 14 according to investment profits and performance of the investment strategy 12. At the same time, the online database 11 gives the investment strategy 12 an investment rating 15 to determine which grade the investment strategy 12 is. When investors receive authorization to access to the investment strategy 12, combinations and analyses of various investment strategies 12 are done by a portfolio analysis module 16 of the trading platform 1 so as to get higher profit. Furthermore, the trading platform 1 also includes an automated order module 17 that allows investors placing orders automatically according to their settings and the authorized investment strategy 12.

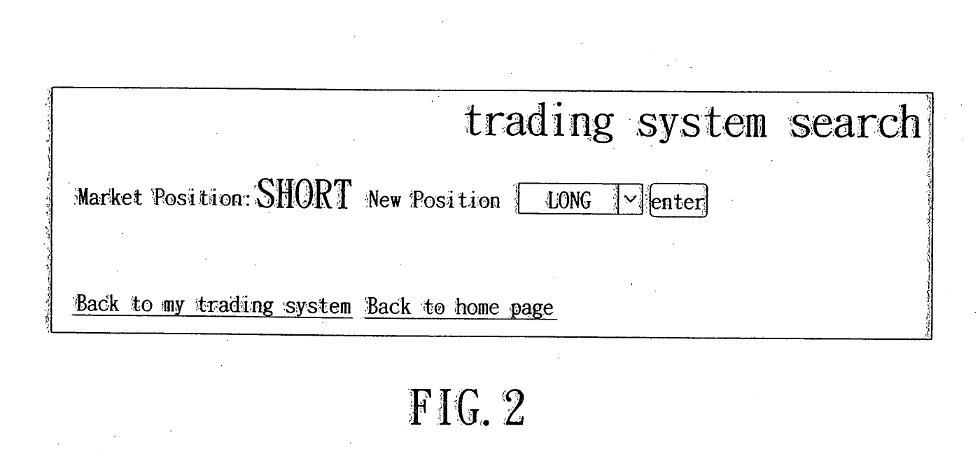

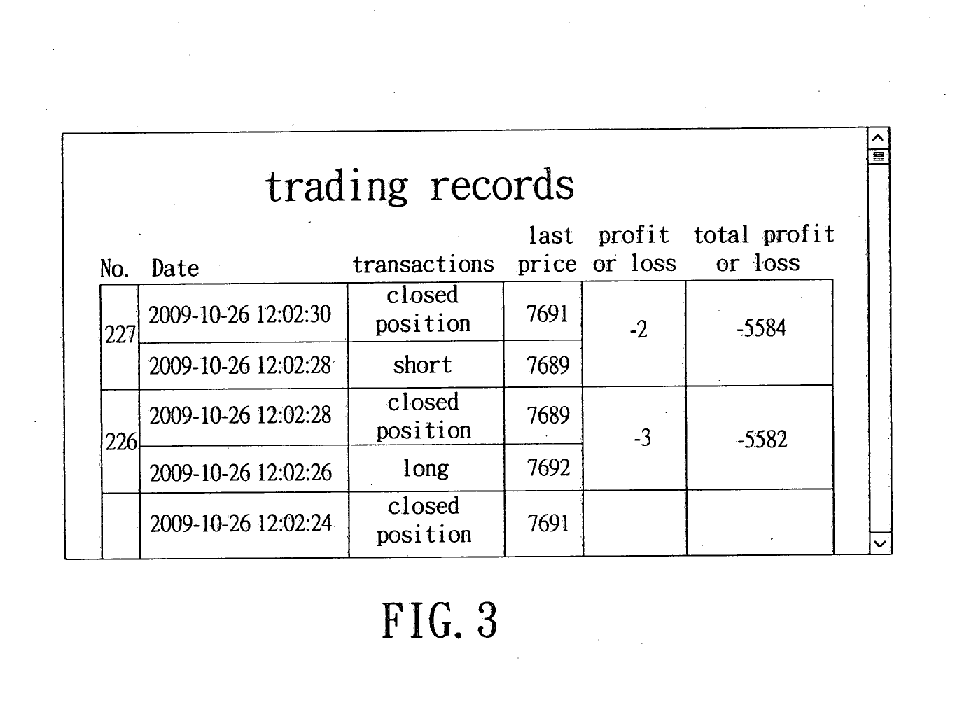

In use, the strategic provider gets free upload space for strategy management and recording after becoming members of the trading platform 1. The strategic provider only needs to select strategies and order time intended to be uploaded, press icons and send out. Thus the price at that time and trading records of long-short strategy are recorded on the website, as shown by a screen capture in FIG. 2. Each trading record that investors access the investment strategies 12 offered by strategic providers is left on the present trading platform 1. When the investors use the trading platform 1, a value of a break-even point at that moment is automatically recorded and sum up all the profits and losses, as illustrated by a screenshot in FIG. 3. Investors only need to operate the trading platform 1 by themselves or programs at proper time and there is no need to reveal any details regarding the investment strategy 12 to the trading platform 1. Thus all information will be kept confidential.

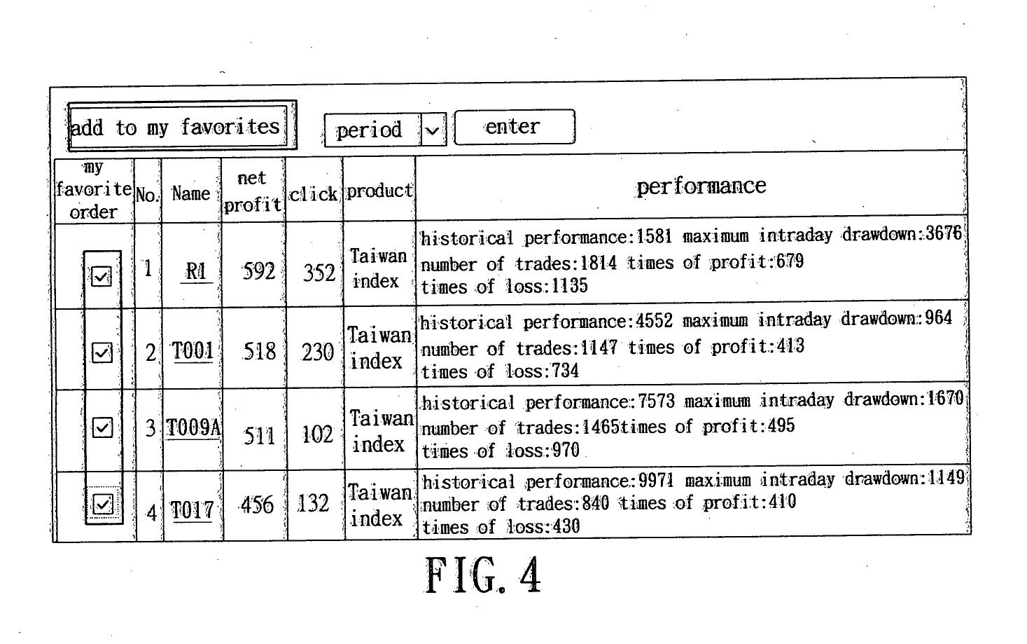

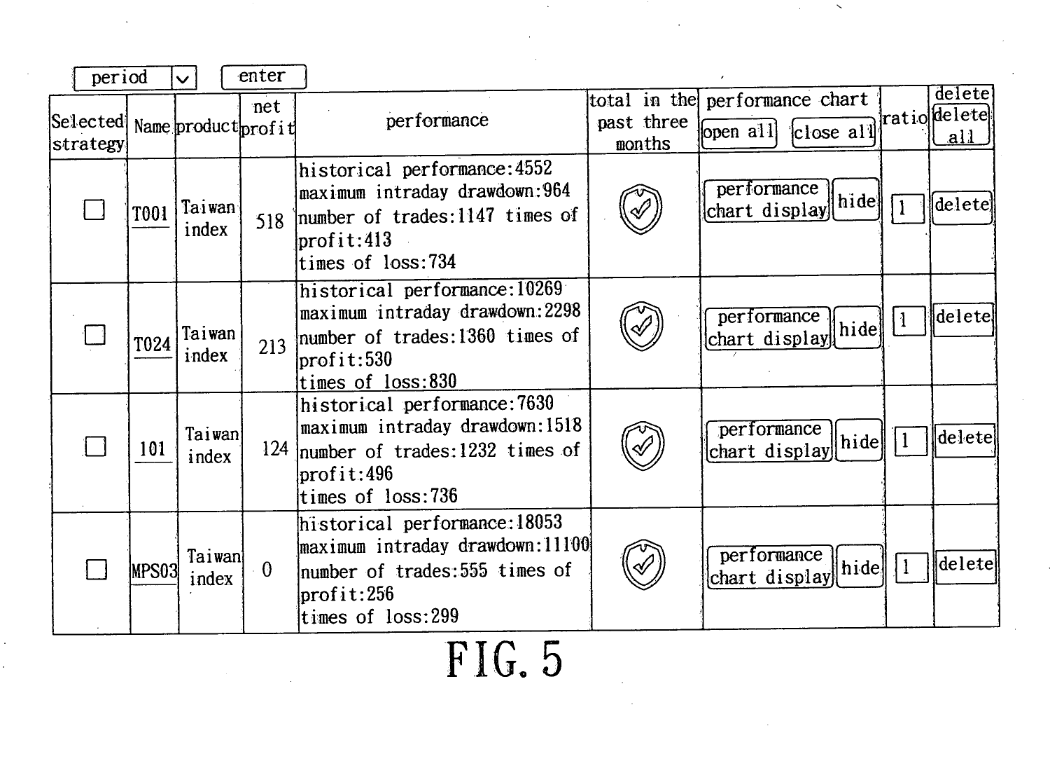

Also refer to screen captures in FIG. 4 and FIG. 5, screen captures are revealed. When investors are interested in a single investment strategy 12 or multiple investment strategies 12 displayed on the trading platform 1, they can order the single investment strategy 12 or these investment strategies 12 by a billing system of the trading platform 1 and pay an access fee to the trading platform 1 correspondingly. The access fee is shared by the trading platform 1 and the strategic providers. Then the investment strategies 12 offered by the strategic providers are authorized and accessed easily. The investment strategies 12 can be ordered and authorized to be used by multiple investors at the same time, not limited to a single investor. As to the strategy providers, they can receive part of a license fee according to the number of the investors that use their investment strategies 12. The license fee is determined by biding of the investors intending to use the investment strategies 12 or configured by the trading platform 1. The license fee is shared by the shared by the trading platform 1 and the strategic providers.

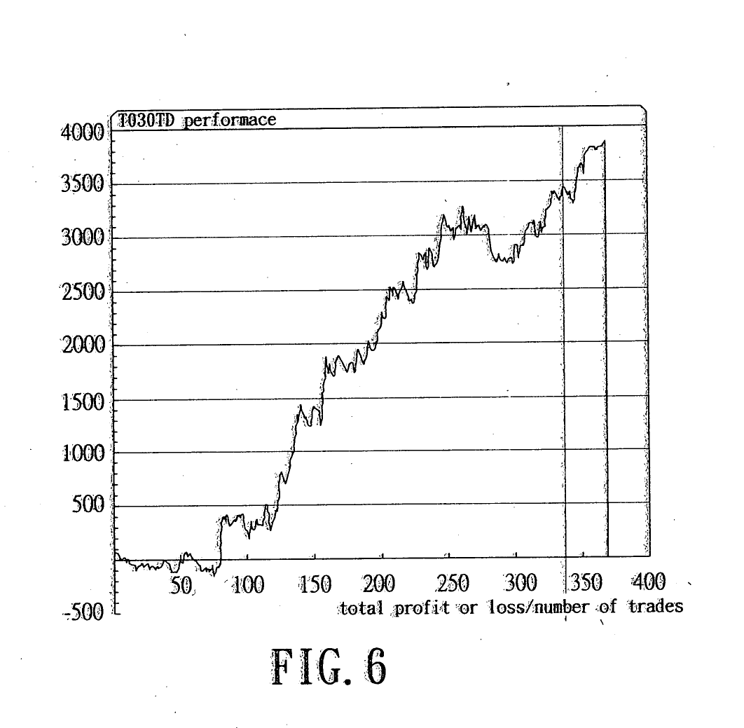

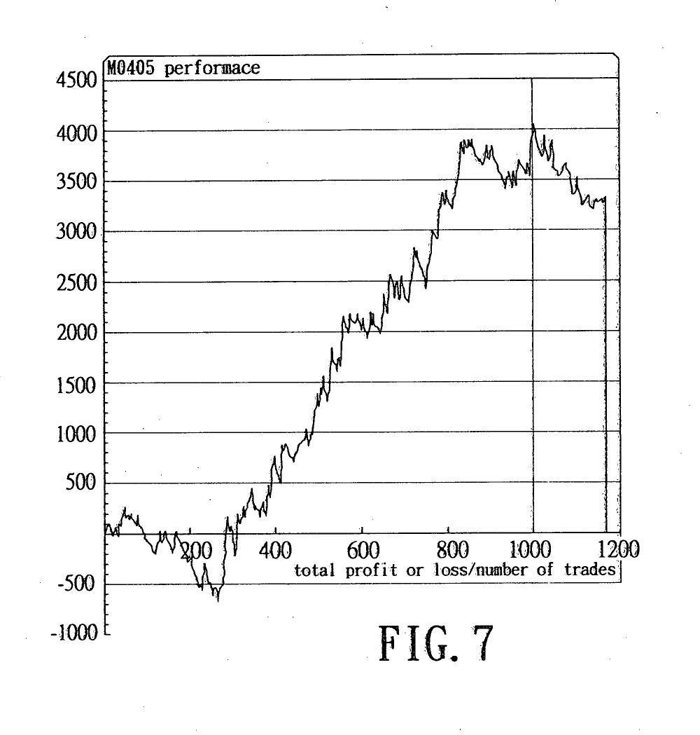

The strategy verification 13 of the investment strategies 12 provided by strategic providers is run by the online database 11 of the trading platform 1. The strategic providers upload historical performance of the investment strategies 12 and the trading platform 1 provides a figure or an indicator to show difference between the historical performance and simulated performance. The historical performance is compared with the simulated performance recorded in the trading platform 1 so as to view whether the historical performance is reliable by data visualization. A lot of investment strategies 12 have an overfitting problem. Although the historical performance is good, it is not consistent with market performance, how disappointing. The trading platform 1 simplifies the verification processes as much as possible and this helps investors a lot in selecting their investment strategies 12. Refer to FIG. 6, a screen capture is shown. This is a screenshot on the compute monitor showing the strategy verification 13 of the investment strategy 12 numbered T030TD. The performance graph on the left side of a line is a historical performance and the performance graph on the right side of a line is a simulated performance recorded by the trading platform 1. Thus a comparison is made so as to check whether the performances match each other. The strategic providers upload the historical performance of the strategy and the trading platform 1 converts data received into figures and indicators. By the figures and indicators, features of the strategy are learned. The figures can also be compared with performance of other strategy so as to know advantages and disadvantages of this strategy more certainly. Furthermore, refer to FIG. 7, a screen capture on the compute monitor showing the strategy verification 13 of the investment strategy 12 numbered M0405 is revealed. The performance graph on the left side of a line is a historical performance and the performance graph on the right side of a line is a simulated performance recorded by the trading platform 1. After comparing, it is learned that overfitting occurs in this investment strategy 12 and there is a significant difference between the historic performance and actual performance of real trades.

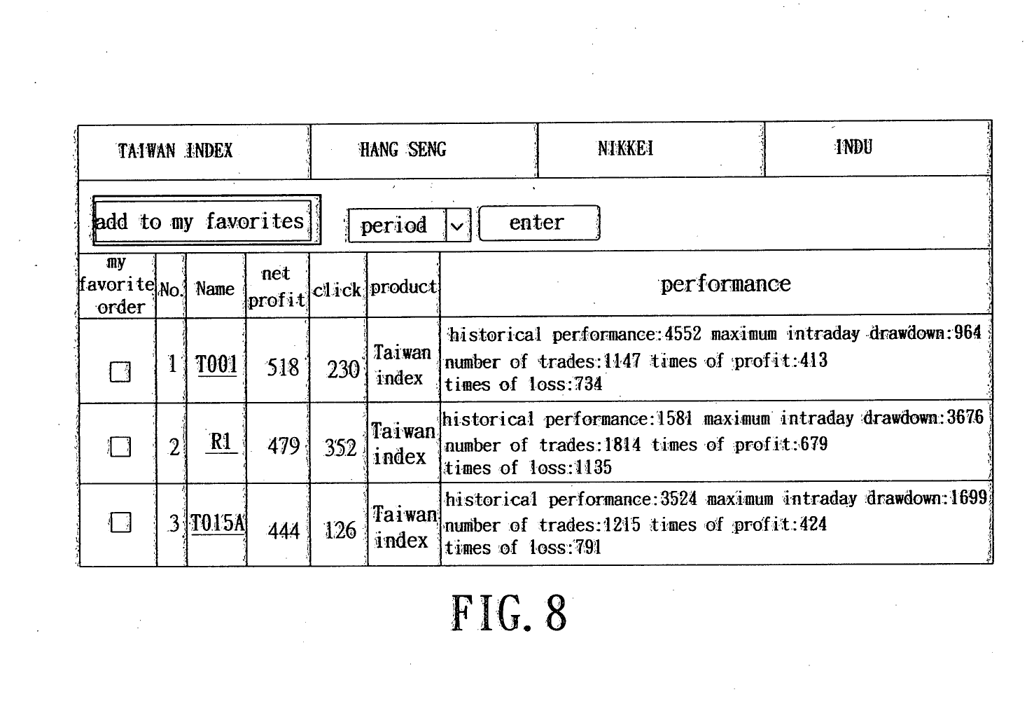

In the trading platform 1, the investment strategies 12 provided by strategic providers are used to hold a strategy competition 14 by the online database 11. Refer to FIG. 8, a screenshot shows that: in the strategy competition 14, various products are divided into different groups to be compared in each group so as to show difference among respective investment strategy 12. The strategies 12 are arranged in an order according to time period (week, month, etc.), various indicators such as VAR (value-at-Risk), VOL (volume), PF (project finance), and so on and performance in the strategy competition 14.

In the trading platform 1, the online database 11 also gives the investment strategy 12 the investment rating 15. When respective values and indicators of the investment strategy 12 meet specific requirements of a grade rated by the trading platform 1, the trading platform 1 automatically gives a rating to the investment strategy 12 that is rated with different icons such as stars. This makes investors to learn features of each investment strategy 12 in a more visual way.

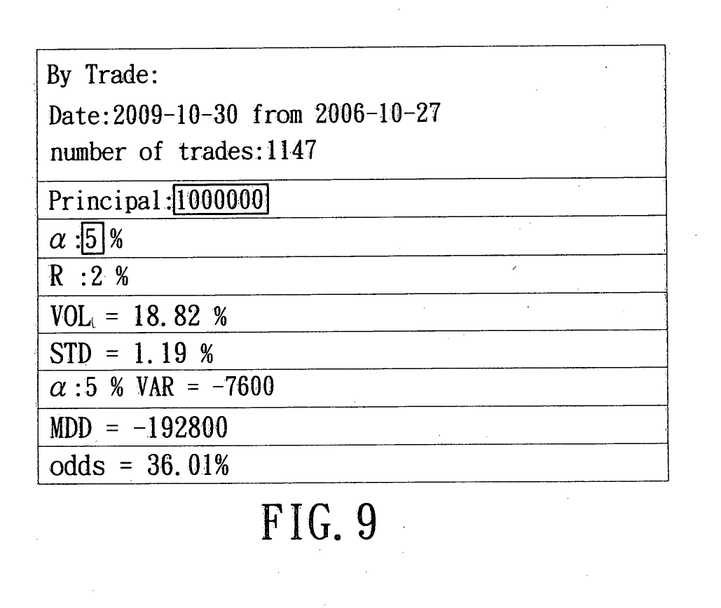

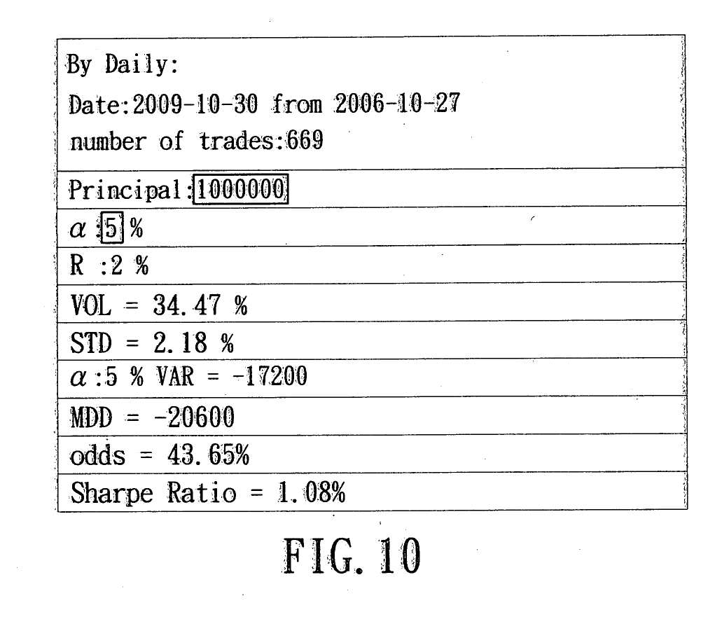

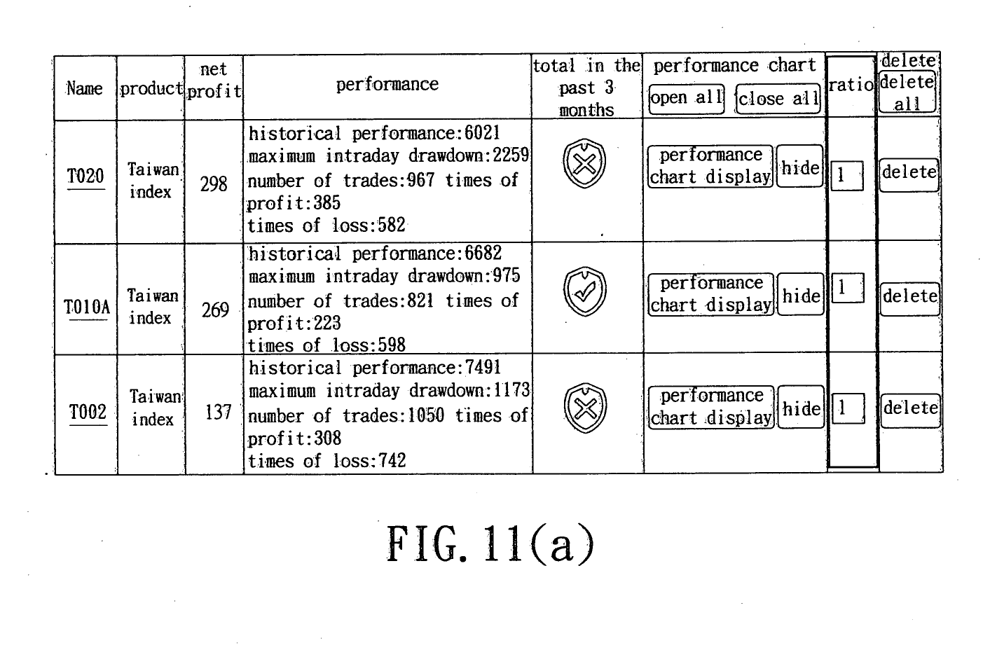

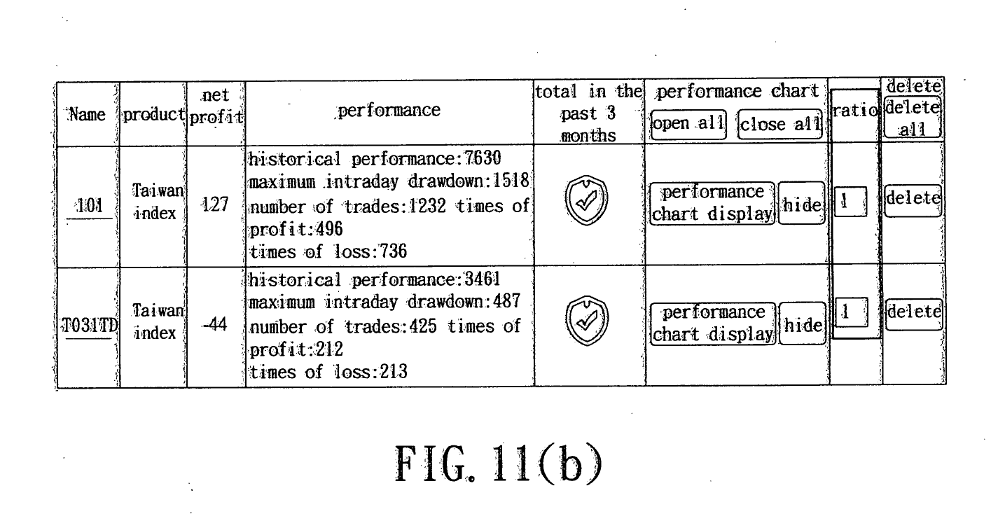

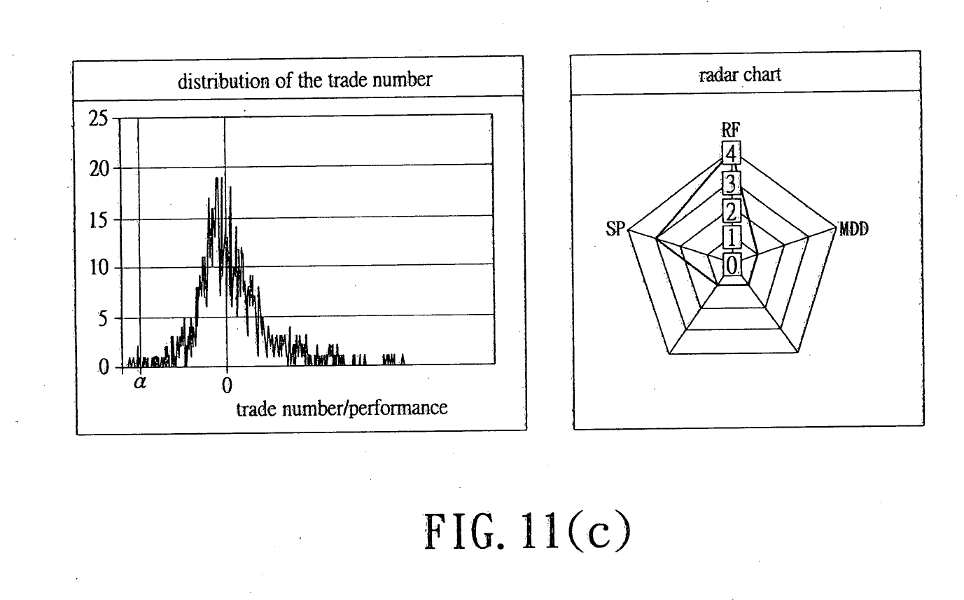

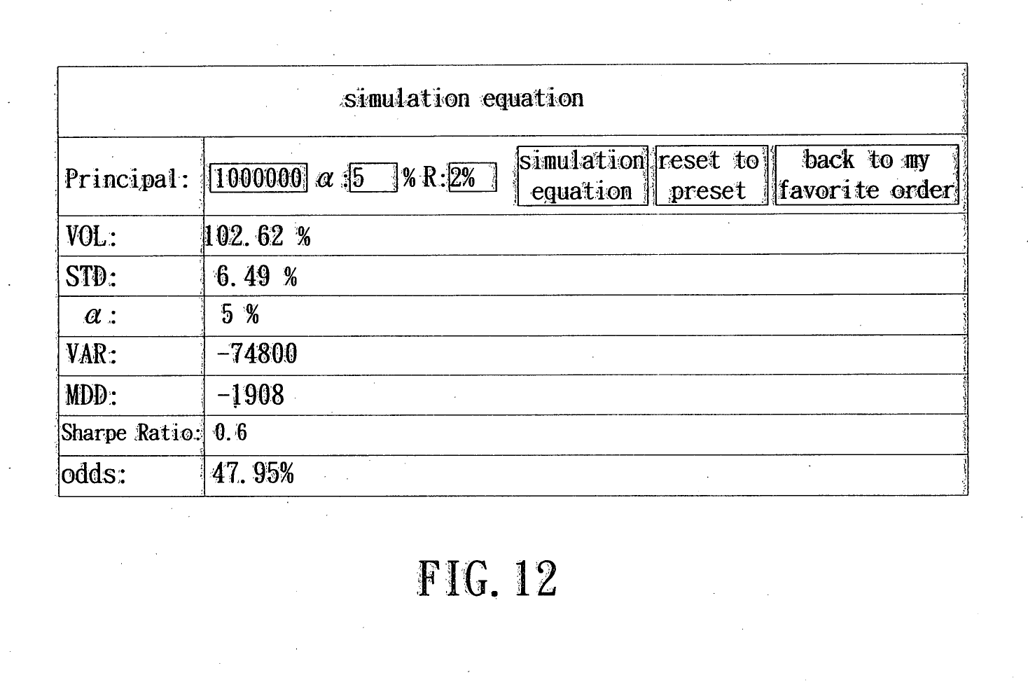

When the user is authorized to access a single investment strategy 12 or multiple investment strategies 12, he simulates and analyzes the single investment strategy 12 by the portfolio analysis module 16. There are two operation modes of the single investment strategy 12—by Trade (number of trades) (refer to a screenshot in FIG. 9) and by Daily (days) (refer to a screenshot in FIG. 10). The result of the mode is converted to a figure for display. The investor can also use the portfolio analysis module 16 to combine, analyze, and optimize multiple investment strategies 12. For example, the investor can select three investment strategies 12. Then the trading platform 1 finds out the optimal portfolio of the selected investment strategies 12 according to a target set by the investor. Thus the optimal performance, the maximum Sharp ratio, or the optimal volatility index of the portfolio of the investment strategies 12 is displayed so as to achieve the optimal application of the portfolio of the investment strategies 12 as shown in screenshots in FIGS. 11(a)-11(c) and FIG. 12. After the operations of the strategy verification 13, the strategy competition 14, and the investment rating 15, it is learned that not all the investment strategies 12 provided by strategic providers are good strategies. Thus the investor can use the portfolio analysis module 16 to find out a portfolio of different investment strategies 12 respectively provided by different strategic providers. The portfolio that combines different investment strategies 12 may have complementary effects on performance so as to make the investment strategy portfolio more complete.

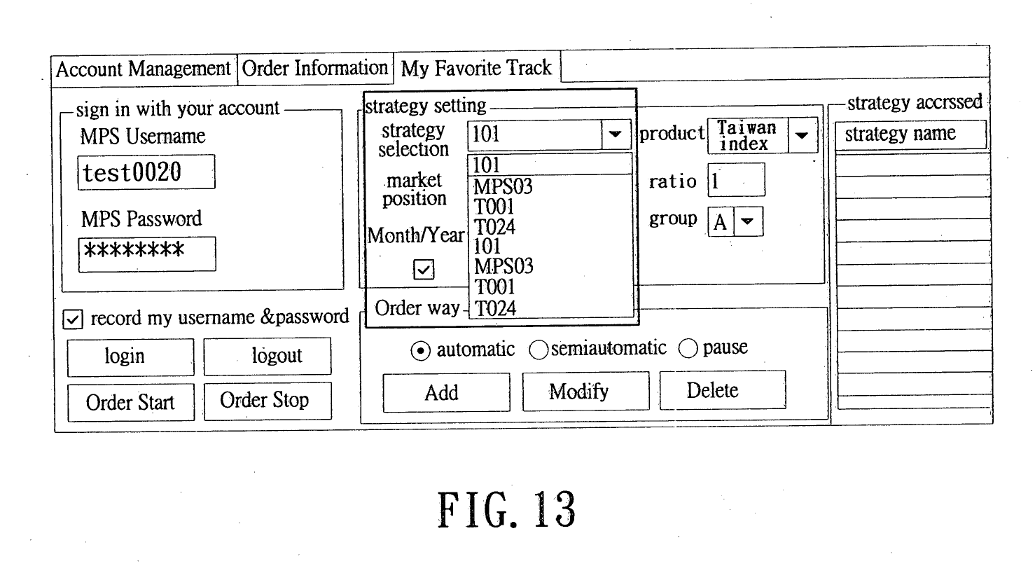

Refer to a screenshot in FIG. 13, after being authorized to access a single investment strategy 12 or multiple investment strategies 12, the investor can place orders automatically or semi-automatically by the automated order module 17 according to the selected investment strategies 12 and corresponding settings. Moreover, the investor can receive information and send instructions by short messages or e-mails. Thus the investor has more flexible settings and operations.

In summary, compared with structure of trading platforms available now, the trading platform of the present invention not only allows investors to select investment strategies provided by strategic providers according to ratings and verification of the investment strategies as they need after becoming members, but also completes authorization and access of the investment strategies automatically. Thus investors don't need to find the strategic providers in order to get the authorization. Moreover, the investors can combine and analyze various authorized investment strategies so as to achieve the optimal performance. Furthermore, the trading platform places orders automatically according to investors' investment portfolios and settings. Thus the trading platform is of greater practical value.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents

What is claimed is:

1. A program trading platform comprising an online database, a portfolio analysis module and an automated order module, wherein the online database allows strategic providers to offer various investment strategies and perform a strategy verification of each investment strategy provided by the strategic provider; the online database also holds a strategy competition for the investment strategies and simultaneously gives each investment strategy an investment rating to determine which grade the investment strategy is; after being authorized to access to the investment strategy, the investors combine and analyze the investment strategy by the portfolio analysis module while the automated order module of the trading platform allows investors placing orders automatically according to the authorized investment strategy.

2. The device as claimed in claim 1, wherein each trading record that investors access the investment strategies offered by the strategic providers is left on the present trading platform and a value of a break-even point at that moment is automatically recorded and sum up all the profits and losses by the trading platform while the investors operating the trading platform; the investors only need to operate the trading platform by themselves or programs at proper time and there is no need to reveal any details regarding the investment strategies to the trading platform so as to keep information related to the investment strategies in confidence.

3. The device as claimed in claim 1, wherein the investors order at least one investment strategy by a billing system of the trading platform and pay an access fee to the trading platform correspondingly when the investors are interested in the single investment strategy so that the investors are authorized to access the investment strategy provided by the strategic providers easily.

4. The device as claimed in claim 1, wherein the strategy verification of the investment strategies provided by strategic providers is run by the online database of the trading platform and the strategic providers upload historical performance of the investment strategies so that the trading platform provides a figure or an indicator of each investment strategy to show difference between the historical performance and simulated performance, and compare the historical performance with the simulated performance so as to view whether the historical performance is reliable by data visualization.

5. The device as claimed in claim 1, wherein the investment strategies provided by the strategic providers are used to hold a strategy competition by the online database of the trading platform, various products are divided into different groups to be compared in each group so as to show difference among respective investment strategy and then arrange in an order according to time period, various indicators and performance.

6. The device as claimed in claim 1, wherein the online database of the trading platform gives the investment strategy the investment rating and the trading platform automatically gives a rating to the investment strategy when respective values and indicators of the investment strategy meet requirements of a grade rated by the trading platform.

7. The device as claimed in claim 1, wherein the investor simulates and analyzes the single investment strategy by the portfolio analysis module when the investor is authorized to access the investment strategy and there are two operation modes of the single investment strategy by Trade (number of trades) and by Daily (days); a result of each mode is converted to a figure for display.

8. The device as claimed in claim 1, wherein the investor can also use the portfolio analysis module to combine, analyze, and optimize multiple investment strategies after being authorized to access to the investment strategies; the trading platform finds out optimal portfolio of the selected investment strategies according to a target set by the investor; the optimal performance, maximum Sharp ratio, or the optimal volatility index of the portfolio of the investment strategies are viewed so as to achieve the optimal application of the portfolio of the investment strategies.

9. The device as claimed in claim 1, wherein the investor places orders automatically or semi-automatically by the automated order module according to the selected investment strategies after being authorized to access the investment strategy and the investor receives information as well as send instructions by short messages or e-mails; thus the investor has more flexible settings and operations of the trading platform.
